(19) United States
(12) Patent Application Publication
(10) Pub. No.: US 2013/0059032 A1
(43) Pub. Date: Mar. 7, 2013

(54) Blends for Fermented Milk Products

(71) Applicants: Wei Li, San Diego, CA (US); Zhi-Fa Yang, San Diego, CA (US); Todd Talashek, San Diego, CA (US)

(72) Inventors: Wei Li, San Diego, CA (US); Zhi-Fa Yang, San Diego, CA (US); Todd Talashek, San Diego, CA (US)

(73) Assignee: CP KELCO U.S., INC., Atlanta, GA (US)

(21) Appl. No.: 13/600,828

(22) Filed: Aug. 31, 2012

Related U.S. Application Data
(60) Provisional application No. 61/530,573, filed on Sep. 2, 2011.

(51) Int. Cl. A23C 9/137

(52) U.S. Cl. 426/34; 426/575

(57) ABSTRACT

A stabilizing additive for compositions, e.g., fermented milk products, is disclosed comprising xanthan gum and iota-carrageenan wherein the weight percentage of the xanthan gum in the stabilizing additive is higher than the weight percentage of the iota-carrageenan. The xanthan gum can be reduced pyruvate or non-pyruvylated xanthan. The stabilizing additive can further comprise a galactomannan. The composition can further comprise starch. Also disclosed is a method for making a fermented milk product comprising adding the stabilizing additive to milk and fermenting the milk or adding the stabilizing additive to already fermented milk. Fermented milk products comprising the additive can include, e.g., yogurt, drinkable yogurt, kefir or Ymer.

### CROSS-REFERENCE TO RELATED APPLICATIONS

This application claims the benefit of U.S. Provisional Application No. 61/530,573, filed Sep. 2, 2011.

### FIELD OF THE INVENTION

This invention relates to blends or additives for edible compositions comprising fermented milk.

### BACKGROUND

Fermented milk products—including, for example, cultured dairy foods, cultured dairy products, or cultured milk products—are among the most widely consumed foods in the world today, and enjoyed by people of nearly all cultures and backgrounds. Yogurt, or yoghurt, is perhaps the most well-known fermented milk product, but other popular fermented milk products include kefir, Ymer, and several fermented milk products with probiotic cultures.

Generally, yogurt is produced by a fermentation process during which a weak milk protein gel develops due to a drop of pH (typically to a pH of less than 5.0) by lactic acid producing organisms, including, for example, Streptococcus thermophilus or Lactobacillus delbrueckii subsp. bulgaricus. Fermentation of lactose produces lactic acid, which acts on milk protein to give yogurt its texture and characteristic tang.

In a typical process, milk is heat treated to kill any undesirable bacteria and to denature the milk proteins so that they set together rather than form curds. It is then cooled to about 45° C. The bacteria culture is added, and this temperature is maintained for 4 to 7 hours for fermentation. It is normal in commercial yogurt production to homogenize and/or concentrate the milk prior to its fermentation. The addition of stabilizers and/or gums to the milk to improve viscosity and texture is also fairly common in commercial large-scale yogurt manufacturing.

Stabilizers, in some instances, are used to improve shelf stability, create texture, and add body and/or creaminess, especially in low or non-fat type yogurts. Currently, the yogurt stabilizer market is dominated by modified starch, gelatin, and pectin. Due to the synthetic nature of modified starch, this stabilizer is prohibited in many countries. Furthermore, consumers are continuously demanding the use of all natural ingredients. In addition, modified starch usually provides a pasty mouth feel, and pectin typically causes syneresis problems during storage. Generally, there are a limited number of natural ingredients used in yogurt that can provide both a great or desirable texture and storage stability.

Xanthan gum generally has a pseudoplastic or shear-thinning behavior characterized by a decrease in apparent viscosity in response to an increase in shear rate. It is well known that its ability to hydrate in either hot or cold water allows xanthan gum to be used in a broad variety of applications, including, for example, pharmaceuticals, household products, foods, and personal care products.

Xanthan gum has been widely used in a variety of food products. However, no successful yogurt formulation has been made using xanthan gum as a major or primary stabilizer due to its general incompatibility with milk protein at low pH. The interaction between negatively charged groups in xanthan and positively charged groups of protein at low pH typically leads to bridge flocculation of milk protein, which pulls the protein out of the solution. In other words, xanthan gum may cause precipitation of the protein or phase separation. Thaiudom, et al. tested the effect of kappa-carrageenan on milk protein and polysaccharide mixtures, and reported that xanthan gum was “most incompatible” with milk proteins. Thaiudom, S. et al. INT. DAIRY J. 13, 2003, 763-771.

Galactomannans, including tara gum, have been used in food applications for many years, primarily in Europe. Tara gum originates from the seeds of the tara bush that are indigenous to Peru. It provides food processors with several advantages in a wide range of non-fat and low-fat food applications, including frozen desserts, cultured dairy products, condiments, baked goods, and salad dressings. Similar to locust bean gum, tara gum acts synergistically with kappa-carrageenan and xanthan gum to increase gel strength and make such gels less prone to syneresis. This synergy takes the form of producing strong gels when individual components are non-gelling or can result in more subtle effects such as shorter flow characteristics, better mouthfeel, or enhanced suspending ability.

Synergistic interactions between galactomannans and xanthan gum are well documented. At high total gum concentrations, aqueous solutions of galactomannans and xanthan gum will form elastic gels. The lower the level of galactose substitution on the mannose backbone, the greater the synergy of the galactomannan with xanthan gum. For example, locust bean gum (which contains about 20% galactose) forms strong elastic gels in combination with equal amounts of xanthan gum in aqueous solutions. Guar gum (which contains about 35% galactose) forms weaker elastic gels when combined with xanthan gum in aqueous solutions.

These synergistic effects between xanthan gum and galactomannans have been reported in numerous applications; however, xanthan gum-galactomannan blends with a significant amount of xanthan gum have not been used in fermented milk products due to the general incompatibility of xanthan gum with milk proteins, particularly at low pH.

Carrageenans are a family of linear sulfated polysaccharides which are extracted from red seaweeds and have been used as food additives for hundreds of years. Carrageenan is a vegetarian and vegan alternative to gelatin. Three well-known types of carrageenans include kappa-, iota-, and lambda-carrageenans. These three carrageenans have different percentages of ester sulfate groups on their repeating galactose units. Iota-carrageenan has sulfate groups on approximately 32% of its repeating galactose units.

Blends or additives are needed for edible compositions containing fermented milk that impart to the compositions the benefits of xanthan gum, while avoiding or lessening the negative interactions between xanthan gum and milk protein. Blends or additives are also needed that use all-natural ingredients, enhance texture and/or taste, and/or provide long-term stability.

### BRIEF SUMMARY

In one aspect, this disclosure relates to stabilizing additives for edible compositions comprising fermented milk. In one embodiment, the stabilizing additives comprise xanthan gum and iota-carrageenan. In other embodiments, the stabilizing additives comprise xanthan gum, iota-carrageenan, and at least one galactomannan. In certain embodiments, the weight percentage of xanthan gum in the stabilizing additive is higher than the weight percentage of the iota-carrageenan. In further embodiments, the weight percentage of xanthan gum in the stabilizing additive is higher than the weight percentage of the iota-carrageenan and is higher than the weight percentage of the at least one galactomannan. In some embodiments, xanthan gum is present in the stabilizing additive in an amount of at least about 50% by weight of the stabilizing additive. In other embodiments, the edible compositions and stabilizing additives are substantially free of microcrystalline cellulose and cellulose fibers. In still other embodiments, the edible compositions comprise at least one starch.

In one embodiment, the xanthan gum is a native xanthan gum, a reduced pyruvate xanthan gum (RPX), a non-pyruvylated xanthan gum (NPX), or any combination thereof. In certain embodiments, the at least one galactomannan is tara gum, locust bean gum, fenugreek gum, guar gum, or any combination thereof.

In another aspect, this disclosure relates to edible compositions comprising a stabilizing additive that comprises xanthan gum and iota-carrageenan. In some embodiments, the stabilizing additive comprises xanthan gum, iota-carrageenan, and at least one galactomannan. In one embodiment, the stabilizing additive is present in the edible composition in an amount of from about 0.1% to about 1.0% by weight of the edible composition. In certain embodiments, the edible compositions are fermented milk products, including, for example, yogurt, drinkable yogurt, kefir, or Ymer.

In yet another aspect, this disclosure relates to methods for preparing edible compositions, including, for example, fermented milk products. In one embodiment, the method comprises combining a stabilizing additive with milk, followed by fermenting the milk. In another embodiment, the method comprises fermenting milk, followed by adding the stabilizing additive to the fermented milk. In certain embodiments, the stabilizing additive comprises xanthan gum and iota-carrageenan. In other embodiments, the stabilizing additive comprises xanthan gum, iota-carrageenan, and at least one galactomannan.

Additional aspects will be set forth in part in the description which follows, and in part will be obvious from the description, or may be learned by practice of the aspects described below. The advantages and aspects described below will be realized and attained by means of the elements and combinations particularly pointed out in the appended claims. It is to be understood that both the foregoing general description and the following detailed description are exemplary and explanatory and are not restrictive.

### DETAILED DESCRIPTION

Before the present compositions and/or methods are disclosed and described, it is to be understood that the aspects described below are not limited to specific embodiments, specific embodiments as such may, of course, vary. It is also to be understood that the terminology used herein is for the purpose of describing particular aspects only and is not intended to be limiting.

In this specification and in the claims which follow, reference will be made to a number of terms which shall be defined to have the following meanings:

It must be noted that, as used in the specification and the appended claims, the singular forms “a,” “an,” and “the” include plural referents unless the context clearly dictates otherwise. Thus, for example, reference to “an emulsifier” includes mixtures of emulsifiers; reference to “a gum” includes mixtures of two or more such gums, and the like.

“Optional” and “optionally” means that the subsequently described event or circumstance may or may not occur and that the description includes instances where the event or circumstance occurs and instances where it does not. For example, the phrase “optionally starch” means that the starch may or may not be included and that the description includes both compositions with and without the starch.

Ranges may be expressed herein as from “about” one particular value and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

References in the specification and concluding claims to parts by weight, of a particular element or component in a composition, denote the weight relationship between the component and any other components in the composition for which a part by weight is expressed. Thus, in a composition containing 2 parts by weight of component X and 5 parts by weight component Y, X and Y are present at a weight ratio of 2:5 and are present in such ratio regardless of whether additional components are contained in the composition.

A weight percent of a component, unless specifically stated to the contrary, is based on the total weight of the formulation or composition in which the component is included.

Stabilizing additives have been provided that comprise xanthan gum and iota-carrageenan. In certain embodiments, the weight percentage of xanthan gum in the stabilizing additive is higher than the weight percentage of the iota-carrageenan.

Generally, the stabilizing additives described herein may be used in any edible composition. In some embodiments, the edible compositions include fermented milk products, including, for example, yogurt, low-fat yogurt, or non-fat yogurt. Yogurts, including low or non-fat yogurts, that include the stabilizing additives described herein offer several commercial advantages over current yogurt products that are commercially available. These advantages include, but are not limited to (1) “clean labeling,” i.e., all-natural ingredients; (2) enhanced texture and taste, such as, for example, thick, soft, smooth, creamy, clean, rich, but not pasty taste and/or mouthfeel; and (3) long-term stability, including, for example, no syneresis and/or texture change during storage for at least 2 months—all relative to conventional, commercially-available yogurt products.

In accordance with embodiments of this invention, xanthan gum is used as the major stabilizing additive in fermented milk products, including, for example, yogurt.

According to certain embodiments, the use of a blend or stabilizing additive comprising xanthan gum and iota-carrageenan imparts significantly improved rheological properties to an edible composition, specifically a fermented milk product, including, for example, yogurt, when compared to commercially-available fermented milk products. Applicants surprisingly discovered that a stabilizing additive comprising xanthan gum and iota-carrageenan is capable of imparting desirable rheological properties, such as those described herein, to edible compositions, including fermented milk products such as yogurt.

### Xanthan Gum

Generally, xanthan gum is a microbial polysaccharide that may be produced by a pure culture of aerobic submerged fermentation of Xanthomonas campestris. Native xanthan gum comprises a 1,4-linked-D-glucose backbone with trisaccharide side chains on alternating anhydroglucose units. The side chains are comprised of a glucoronic acid residue between two mannose units. Approximately 50% of the terminal mannose molecules carry a pyruvic acid residue.

Generally, the xanthan gum used in the stabilizing additives described herein can comprise a native xanthan gum, a modified xanthan gum, or any combination thereof.

Native xanthan gums may be prepared from Xanthomonas campestris using a variety of well-known techniques. Native xanthan gums are commercially available.

A modified xanthan gum, as the term is used herein, is one with one or more structural modifications, and includes, but is not limited to, reduced pyruvate xanthan gums (“RPX”) and non-pyruvylated xanthan gums (“NPX”).

As used herein, an RPX is a xanthan gum having a pyruvic acid content of less than about 4%. As used herein, NPX is a de-pyruvylated xanthan gum, or, in other words, a modified xanthan gum having substantially no pyruvic acid content. A modified xanthan gum having “substantially no pyruvate,” as used herein, means a modified xanthan gum having a pyruvate content of up to about 0.5% by weight.

According to certain embodiments, a modified xanthan gum can be prepared by fermentation of any strain capable of producing a modified xanthan gum. In one embodiment, the modified xanthan gum has reduced pyruvate content when compared to that of a native xanthan gum. In another embodiment, the modified xanthan gum has substantially no pyruvate content. In certain embodiments, a suitable modified xanthan gum may be produced using a genetically modified Xanthomonas campestris. (See, e.g., U.S. Pat. No. 6,316,614, and BIOTECHNOL. PROG. 6, 1990, 182-187 for descriptions of similar strains). Examples of strains capable of producing non-pyruvylated xanthan gums include ATCC deposits 53472 and 67344. (See, e.g., U.S. Pat. No. 6,316,614). The modified xanthan gums may be recovered from the fermentation broth and treated using methods known to those skilled in the art (e.g., clarification, pasteurization, precipitation, drying, and milling).

Alternatively, pyruvate substituents may be removed from a native xanthan gum or reduced in number by chemical treatment. (See, e.g., CARBOHYDRATE POLYMERS, 3, 1983, 23-28).

### Iota-Carrageenan

Generally, carrageenans are polysaccharides with linear, sulfated galactose backbones. Iota-carrageenans are those having about 32% sulfate groups on their galactose backbone. Typically, iota-carrageenans are able to undergo a transition from random coil to double helix upon cooling (below about 50° C.). Not wishing to be bound by any particular theory, it is believed that the double helix formation enhances the charge density in the molecular chains, which provides a screening effect between xanthan gum and milk proteins when iota-carrageenans are used in the stabilizing additives described herein. This protective screening is not as strong when kappa-carrageenan is used in the stabilizing additives described herein. Not wishing to be bound by any particular theory, it is believed that the kappa-carrageenans offer less protective screening because their structure includes a lower percentage of sulfate groups (relative to iota-carrageenan), and kappa-carrageenans strongly interact with kappa-casein, which may cause graininess in certain fermented milk products, such as yogurt.

In the stabilizing additives described herein, iota-carrageenan is used to prevent the xanthan-milk protein interaction at low pH. Generally, the iota-carrageenan achieves this without causing graininess of the resulting products, including yogurt.

### Galactomannan

Galactomannans are a group of neutral polysaccharides naturally occurring in the seeds of some species of the Leguminosae family. Galactomannans comprise a mannose backbone with galactose side groups. More particularly, the galactommanan molecule comprises a 1,4-linked β-mannopyranose backbone with branchpoints of a α-D-galactose from the C6 positions of the mannose backbone. The ratio of mannose to galactose varies according to the species of the plant from which the galactomannan is derived. Common galactomannans, and their corresponding ratios of mannose to galactose, include fenugreek gum (1:1), guar gum (2:1), tara gum (3:1), and locust bean gum (4:1). Galactomannans are commonly used in many applications as rheology modifiers and have been shown to behave synergistically in combination with other rheological modifiers.

As the term is used herein, the at least one galactomannan comprises any naturally occurring galactomannan that is commercially available. For example, a galactomannan typically is obtained as a naturally occurring material such as seeds or beans from plants. In certain embodiments, the at least one galactomannan can be fenugreek gum, guar gum, tara gum, locust bean gum, or any combination thereof. In other embodiments, the galactomannan can comprise modified galactomannans. Typically, a modified galactomannan is one in which the galactose substitutions have been modified. In one embodiment, the at least one galactomannan is tara gum, sometimes referred to as tara bean gum.

The at least one galactomannan in the stabilizing additives of certain embodiments described herein can control the protein aggregation in order to achieve the desired texture of the fermented milk product, including, for example, yogurt. In certain fermented milk products, the degree of protein aggregation can be a critical factor in obtaining a desired texture—especially for yogurts. Not wishing to be bound by any particular theory, it is believed that more protein aggregation leads to a grainy and hard texture, whereas less protein aggregation can cause less body in the fermented milk products, especially yogurt. Thus, according to embodiments, xanthan gum and at least one galactomannan are successfully applied together in fermented milk products, including yogurt. It is believed that the adverse interactions between xanthan gum and milk protein at low pH discouraged the use of xanthan gum as a primary additive in products containing fermented milk.

### Stabilizing Additive

As used herein, the term stabilizing additive refers to any combination of at least the following components—both in isolation or in any edible composition: xanthan gum and iota-carrageenan. In certain embodiments, the stabilizing additive stabilizes, thickens, and/or alters the physical texture of the compositions described herein, including fermented milk products, such as yogurt.

Not wishing to be bound by any particular theory, it is believed that the combination of a xanthan gum and iota-carrageenan results in a synergistic interaction that surprisingly gives the desired rheological properties.

In certain embodiments described herein, the present application provides stabilizing additives comprising a blend of natural ingredients that are suitable for use as thickening and/or stabilizing agents in edible composition formulations.

Generally, the stabilizing additives described herein may comprise xanthan gum and iota-carrageenan in any ratio that is effective to impart one or more of the desired properties, including rheological properties, to the stabilizing additive and/or the edible compositions to which the stabilizing additives are introduced. In one embodiment, the weight ratio of xanthan gum to iota-carrageenan in the stabilizing additive is from about 19:1 to about 3:1. In another embodiment, the weight ratio of xanthan gum to iota-carrageenan in the stabilizing additive is from about 16:1 to about 5:1. In yet another embodiment, the weight ratio of xanthan gum to iota-carrageenan in the stabilizing additive is from about 13:1 to about 7:1. In a further embodiment, the weight ratio of xanthan gum to iota-carrageenan in the stabilizing additive is from about 11:1 to about 9:1. In a particular embodiment, the weight ratio of xanthan gum to iota-carrageenan in the stabilizing additive is about 10:1.

In certain embodiments, the weight percentage of xanthan gum in the stabilizing additive is higher than the weight percentage of the iota-carrageenan. In other embodiments, the stabilizing additive further comprises at least one galactomannan. In some embodiments, the weight percentage of the xanthan gum in the stabilizing additive is higher than the weight percentage of the at least one galactomannan. In one embodiment, xanthan gum is present in the stabilizing additive in an amount of at least about 50% by weight of the stabilizing additive. In an additional embodiment, xanthan gum is present in the stabilizing additive in an amount of at least about 55% by weight of the stabilizing additive. In another embodiment, xanthan gum is present in the stabilizing additive in an amount of at least about 60% by weight of the stabilizing additive. In still another embodiment, xanthan gum is present in the stabilizing additive in an amount of at least about 65% by weight of the stabilizing additive. In yet another embodiment, xanthan gum is present in the stabilizing additive in an amount of at least about 70% by weight of the stabilizing additive. In a further embodiment, xanthan gum is present in the stabilizing additive in an amount of at least about 75% by weight of the stabilizing additive. In a still further embodiment, xanthan gum is present in the stabilizing additive in an amount of at least about 80% by weight of the stabilizing additive. In yet another embodiment, xanthan gum is present in the stabilizing additive in an amount of at least about 85% by weight of the stabilizing additive. In another additional embodiment, xanthan gum is present in the stabilizing additive in an amount of at least about 90% by weight of the stabilizing additive.

In one embodiment, iota-carrageenan is present in the stabilizing additive in an amount of from about 5 to about 25% by weight of the stabilizing additive. In another embodiment, iota-carrageenan is present in the stabilizing additive in an amount of from about 5 to about 20% by weight of the stabilizing additive. In yet another embodiment, iota-carrageenan is present in the stabilizing additive in an amount of from about 5 to about 15% by weight of the stabilizing additive. In a further embodiment, iota-carrageenan is present in the stabilizing additive in an amount of from about 7.5 to about 12.5% by weight of the stabilizing additive. In a still further embodiment, iota-carrageenan is present in the stabilizing additive in an amount of from about 9 to about 11% by weight of the stabilizing additive. In one particular embodiment, iota-carrageenan is present in the stabilizing additive in an amount of about 10% by weight of the stabilizing additive.

In certain embodiments, the stabilizing additive further comprises at least one galactomannan. In some embodiments, galactomannan is present in the stabilizing additive in an amount of from about 5 to about 35% by weight of the stabilizing additive. In one embodiment, galactomannan is present in the stabilizing additive in an amount of from about 10 to about 30% by weight of the stabilizing additive. In other embodiments, galactomannan is present in the stabilizing additive in an amount of from about 15 to about 25% by weight of the stabilizing additive. In some embodiments, galactomannan is present in the stabilizing additive in an amount of about 20% by weight of the stabilizing additive. In a further embodiment, galactomannan is present in the stabilizing additive in an amount of from about 5 to about 30% by weight of the stabilizing additive. In a still further embodiment, galactomannan is present in the stabilizing additive in an amount of from about 5 to about 25% by weight of the stabilizing additive. In another further embodiment, galactomannan is present in the stabilizing additive in an amount of from about 5 to about 20% by weight of the stabilizing additive. In still another further embodiment, galactomannan is present in the stabilizing additive in an amount of from about 5 to about 15% by weight of the stabilizing additive. In a certain embodiment, galactomannan is present in the stabilizing additive in an amount of about 10% by weight of the stabilizing additive. In one particular embodiment, galactomannan is present in the stabilizing additive in an amount of from about 10 to about 35% by weight of the stabilizing additive. In another particular embodiment, galactomannan is present in the stabilizing additive in an amount of from about 15 to about 35% by weight of the stabilizing additive. In yet another particular embodiment, galactomannan is present in the stabilizing additive in an amount of from about 20 to about 35% by weight of the stabilizing additive. In a further particular embodiment, galactomannan is present in the stabilizing additive in an amount of from about 25 to about 35% by weight of the stabilizing additive. In another certain embodiment, galactomannan is present in the stabilizing additive in an amount of about 25% by weight of the stabilizing additive. In yet another certain embodiment, galactomannan is present in the stabilizing additive in an amount of about 15% by weight of the stabilizing additive. In a further certain embodiment, galactomannan is present in the stabilizing additive in an amount of about 30% by weight of the stabilizing additive.

In a particular embodiment, xanthan gum is present in the stabilizing additive in an amount of about 91% by weight of the stabilizing additive, and iota-carrageenan is present in an amount of about 9% by weight of the stabilizing additive. In another particular embodiment, xanthan gum is present in the stabilizing additive in an amount of about 95% by weight of the stabilizing additive, and iota-carrageenan is present in an amount of about 5% by weight of the stabilizing additive. In yet another particular embodiment, xanthan gum is present in the stabilizing additive in an amount of about 85% by weight of the stabilizing additive, and iota-carrageenan is present in an amount of about 15% by weight of the stabilizing additive. In a still further embodiment, xanthan gum is present in the stabilizing additive in an amount of about 75% by weight of the stabilizing additive, and iota-carrageenan is present in an amount of about 25% by weight of the stabilizing additive.

In one particular embodiment, xanthan gum is present in the stabilizing additive in an amount of about 65% by weight of the stabilizing additive, iota-carrageenan is present in the stabilizing additive in an amount of about 10% by weight of the stabilizing additive, and at least one galactomannan is present in the stabilizing additive in an amount of about 25% by weight of the stabilizing additive. In another particular embodiment, xanthan gum is present in the stabilizing additive in an amount of about 75% by weight of the stabilizing additive, iota-carrageenan is present in the stabilizing additive in an amount of about 10% by weight of the stabilizing additive, and at least one galactomannan is present in the stabilizing additive in an amount of about 15% by weight of the stabilizing additive. In a further particular embodiment, xanthan gum is present in the stabilizing additive in an amount of about 70% by weight of the stabilizing additive, iota-carrageenan is present in the stabilizing additive in an amount of about 10% by weight of the stabilizing additive, and at least one galactomannan is present in the stabilizing additive in an amount of about 20% by weight of the stabilizing additive.

In certain embodiments, the edible compositions and stabilizing additives are substantially free of microcrystalline cellulose and/or cellulose fibers. In one embodiment, the components of the stabilizing additive are not co-processed with microcrystalline cellulose, cellulose fibers, or any other materials.

### Applications

In another aspect, this disclosure provides food products and edible compositions comprising the stabilizing additives described herein. Generally, the food products or edible compositions comprise the stabilizing additive in an amount effective to impart the desired properties, such as rheological and sensory properties, to the food product. In certain embodiments, the edible compositions are food products containing fermented milk, including, but not limited to yogurt, low-fat yogurt, non-fat yogurt, drinkable yogurt, kefir, and Ymer.

Those skilled in the art will appreciate that the properties of the edible composition—including, for example, the rheological and/or sensory properties—may be modified, in part, by modifying the amount of the stabilizing additive present in the food product or edible composition. In one embodiment, the stabilizing additive is present in the edible composition in an amount of from about 0.1 to about 1.0% by weight of the edible composition. In another embodiment, the stabilizing additive is present in the edible composition in an amount of from about 0.3 to about 0.8% by weight of the edible composition. In yet another embodiment, the stabilizing additive is present in the edible composition in an amount of from about 0.4 to about 0.6% by weight of the edible composition.

In some embodiments, the xanthan gum is present in the edible composition in an amount of from about 0.1 to about 1.0% by weight of the edible composition. In certain embodiments, the iota-carrageenan is present in the edible composition in an amount of from about 0.01 to about 0.1% by weight of the edible composition.

In some embodiments, the edible compositions or food products further comprise a starch. As used herein, the term starch refers to any polysaccharides comprising glucose monomers or repeat units that are substantially connected by α-1,4 linkages. In one embodiment, the starch is a modified starch. As used herein, a modified starch is one that is prepared by physically, enzymatically, or chemically treating native starch. In one embodiment, the modified starch comprises THERMTEX® (National Starch Food Innovation, Overland Park, Kans., USA).

Generally, the starch may be present in the edible compositions or food products described herein in any amount necessary to impart beneficial properties. In some embodiments, the stabilizing additive and starch are present in the edible compositions in a ratio of about 1:1 to about 1:5. In certain embodiments, the stabilizing additive and starch are present in the edible compositions in a ratio of about 1:1.5 to about 1:4.5. In other embodiments, the stabilizing additive and starch are present in the edible compositions in a ratio of about 1:2 to about 1:4. In one embodiment, the stabilizing additive and starch are present in the edible composition in a ratio of about 1:1.5. In another embodiment, the stabilizing additive and starch are present in the edible composition in a ratio of about 1:2. In yet another embodiment, the stabilizing additive and starch are present in the edible composition in a ratio of about 1:2.5. In a further embodiment, the stabilizing additive and starch are present in the edible composition in a ratio of about 1:3. In a still further embodiment, the stabilizing additive and starch are present in the edible composition in a ratio of about 1:3.5. In an additional embodiment, the stabilizing additive and starch are present in the edible composition in a ratio of about 1:4. In another additional embodiment, the stabilizing additive and starch are present in the edible composition in a ratio of about 1:4.5.

Generally, the edible compositions described herein may comprise one or more additional components known for use in edible compositions, provided that the additional components are physically and chemically compatible with the blends or stabilizing additives provided herein, or do not otherwise undesirably impair product stability, texture, and/or taste. In certain embodiments, individual amounts of such additional components may range from about 0.001 to about 95% by weight of the food product or edible composition. In some embodiments, the additional components are water soluble (i.e., soluble in water at 25° C.) or water insoluble (i.e., not soluble in water at 25° C.).

The edible compositions provided herein can be characterized by the same rheological and sensory properties used to characterize the rheological and sensory properties of the blends or stabilizing additives above.

Methods for characterizing the sensory properties of edible compositions are well known to those skilled in the art and include the evaluation of the edible compositions by trained panelists of various sensory properties.

Also provided herein is an edible composition comprising the stabilizing additives described herein.

### Methods For Stabilizing Additive Formation and Edible Composition Formulation

Those of ordinary skill in the art will appreciate that the edible compositions and stabilizing additives described herein can be prepared using any suitable method for mixing the components.

In some embodiments, the edible compositions described herein can be made by adding the stabilizing additive to milk, and fermenting the milk. In other embodiments, the edible compositions described herein can be made by fermenting milk, and adding the stabilizing additive to the fermented milk. In one embodiment, the components of the stabilizing additives can be added to the edible compositions in any order or sequence. In another embodiment, the components of the stabilizing additive can be added—collectively or individually—as dry materials or in a liquid.

In certain embodiments, the stabilizing additive is prepared by combining the xanthan gum and iota-carrageenan. In one embodiment, the xanthan gum and iota-carrageenan are combined as dry materials—for example, powders, which may be mixed to form a homogeneous dry powder blend. In another embodiment, the xanthan gum and iota-carrageenan are combined in a liquid, which may be stirred to form a homogeneous solution or a suspension of the components. In yet another embodiment, at least one of the components of the stabilizing additive is added as a dry material, such as a powder, to a solution or suspension of at least one of the remaining components of the stabilizing additive. In one particular embodiment, the stabilizing additive can be formed by combining and optionally mixing a solution of xanthan gum, and a solution of iota-carrageenan. In some embodiments, further additives—including, for example, those described herein—can be added by any of the means described herein for xanthan gum and iota-carrageenan. For example, in one embodiment, at least one galactomannan in dry powder form can be added to dry powders of xanthan gum and iota-carrageenan, and mixed; alternatively, a solution of at least one galactomannan can be combined with the above-described solutions of xanthan gum and/or iota-carrageenan.

Generally, the liquid or liquids above can optionally be removed by any means known to those of skill in the art, including, for example, drying or drying under vacuum. Furthermore, the liquid or liquids can be an appropriate solvent for one or more of the components, thereby forming a solution of one or more of the components. In some embodiments, at least one component of the stabilizing additive can be added to the milk or fermented milk in liquid form, for example, as a suspension or solution.

In certain embodiments, the edible composition further comprises a starch. Similar to the components of the stabilizing additives, the starch generally can be added in any order and in any form to the milk or fermented milk of the edible compositions described herein. Furthermore, the starch can be added as a dry material or in liquid foini, for example, as a solution or suspension. In one embodiment, the starch can be added concurrently with the components of the stabilizing additive. In another embodiment, the starch and the components of the stabilizing additive can be added separately.

Methods of mixing dry powders and/or solutions or suspensions are well known to those skilled in the art. Non-limiting examples of mixing include stirring, shaking, agitation, sonication, etc.

### EXAMPLES

The following examples are put forth so as to provide those of ordinary skill in the art with a complete disclosure and description of how the compositions and/or methods described and claimed herein are made and evaluated and are intended to be purely exemplary and are not intended to limit the scope of what the inventors regard as their invention.

Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric. There are numerous variations and combinations of reaction conditions, e.g., component concentrations, desired solvents, solvent mixtures, temperatures, pressure and other reaction ranges and conditions that can be used to optimize the product purity and yield obtained from the described process. Only reasonable and routine experimentation will be required to optimize such process conditions.

### Example 1

### Preparation of Stabilizing Additive

A stabilizing additive containing 65% by weight xanthan gum, 10% by weight iota-carrageenan, and 25% by weight guar gum was prepared by combining appropriate amounts of each component. The components were combined as dry powders by blending.

### Example 2

### Preparation of Stabilizing Additive

A stabilizing additive containing 75% by weight of xanthan gum, 10% by weight of iota-carrageenan, and 15% by weight of tara gum was prepared by combining appropriate amounts of each component. The components were combined as dry powders by blending.

### Example 3

### Preparation of Stabilizing Additive

A stabilizing additive containing 70% by weight non-pyruvated xanthan gum, 10% by weight iota-carrageenan, and 20% by weight of tam gum was prepared by combining appropriate amounts of each component. The components were combined as dry powders by blending.

### Example 4

### Preparation of Low-Fat Yogurt Using Stabilizing Additives of Examples 1-3

The stabilizing additives of Examples 1-3 were used to make a low-fat yogurt. The low-fat yogurt contained 93.08% by weight 1% fat milk, 5% by weight sugar, 1.5% by weight of milk solid non fat, 0.02% by weight of culture YC470 (Chr. Hansen, Inc., Denmark), and 0.4-0.6% by weight of the stabilizing additives of Example 1-3.

Appropriate amounts of the stabilizing additives of Example 1-3 were added to an appropriate amount of the 1% fat milk and stirred. The mixture was then heated to 75° C. and homogenized at 2000 psi. The homogenized mixture was pasteurized at 89° C. for 10 minutes, and then cooled to 41° C. The culture was added to the pasteurized mixture at 41° C. Fermentation was allowed to occur for 4-6 hours until a pH of 4.55 was reached. The fermented mixture was then cooled down to 25° C. The curds were then broken, placed into cups, and stored at 5° C. in a refrigerator.

### Example 5

### Preparation of Fat-Free Yogurt Using Stabilizing Additives of Examples 1-3

The stabilizing additives of Examples 1-3 were used to make a fat-free yogurt. The fat-free yogurt contained 93.08% by weight skim milk, 5% by weight sugar, 1.5% by weight of milk solid non fat, 0.02% by weight of culture YC470 (Chr. Hansen, Inc., Denmark), and 0.4-0.6% by weight of the stabilizing additives of Example 1-3.

The procedures of Example 4 were repeated to create the fat-free yogurt.

### Example 6

### Preparation of Drinkable Yogurt

The yogurts made in Examples 4 and 5 were diluted with water in an amount of 40-100% by weight of the yogurt to make drinkable yogurts. Optional homogenization can be used to achieve smoother texture of the final products. The drinkable yogurts using this post-dilution process were very stable during storage, because no separation occurred for at least 2 months.

### Example 7

### Carrageenan Screening

Initially, yogurts, such as those described in Example 5, were prepared with different amounts and types of carrageenans to determine which carrageenan imparted the best protection from xanthan gum/milk protein interaction and the most favorable rheological properties to the yogurt.

Table 1 illustrates the results. In the table, GENULACTA® LP41, GENULACTA® LRA-50, and GENUGEL® LC-5 carrageenan are commercially-available products (CP Kelco U.S., Inc., Atlanta, Ga., USA) containing a mixture of both kappa- and iota-carrageenans with different kappa to iota ratios. As shown in Table 1, only iota-carrageenan, including the commercially-available GENUGEL® CS (CP Kelco U.S., Inc., Atlanta, Ga., USA) and commercially-available GENUVISCO® MS (CP Kelco U.S., Inc., Atlanta, Ga., USA) prevented unfavorable milk protein-xanthan interaction and, thus, imparted a smooth texture to the yogurt. The carrageenans containing kappa-type form, including LP41, LRA50, and LC5, produced yogurts of undesirable, grainy texture.

TABLE 1
Carrageenan Screening - Type of Carrageenan

| | Conc. (%) of | |
|---|---|---|
| Conc. (%) & Type of | Xanthan | |
| Carrageenan in Yogurt | Gum in Yogurt | Yogurt Texture |
| 0.06% CJ iota-carrageenan | 0.4% xanthan gum | smooth, a little thin |
| 0.06% LP41 kappa/iota- | 0.4% xanthan gum | a little grainy, thick |
| carrageenan | | |
| 0.06% LRA50 kappa/iota- | 0.4% xanthan gum | grainy, very thick |
| carrageenan | | |
| 0.06% LC5 kappa/iota- | 0.4% xanthan gum | grainy, thick |
| carrageenan | | |
| 0.06% JDS iota-carrageenan | 0.4% xanthan gum | smooth, a little thin |

The results in Table 1 demonstrated that the yogurt compositions with only iota-carragenans, including CJ and JDS, imparted the most desirable rheological properties to the products. The yogurt products that included these iota-carrageenans were both smooth, yet slightly thin. In contrast, the yogurt products containing kappa-carrageenans were generally grainy and thick.

After determining that iota-carrageenans impart the most beneficial properties to the yogurt products, a second screening was performed to determine the optimum concentration of the iota-carrageenan in the yogurt products. Table 2 illustrates these results. The tests in Table 2 were performed with yogurts containing xanthan gum and yogurts containing NPX. The yogurts with xanthan gum and the yogurts with NPX produced the same results.

TABLE 2
Carrageenan Screening - Concentration of Iota-carrageenan

| Conc. (%) | Conc. (%) | | |
|---|---|---|---|
| of iota- | of Xanthan | Conc. (%) | |
| carrageenan | Gum in | of Galact. | |
| in Yogurt | Yogurt | in Yogurt | Yogurt Texture |
| 0.02% iota- | 0.1% Xanthan | 0.3% Guar | grainy, thin |
| carra. | Gum (or NPX) | Gum | |
| 0.04% iota | 0.1% Xanthan | 0.3% Guar | smooth, a little thin, |
| -carra. | Gum (or NPX) | Gum | stringy upon stirring |
| 0.06% iota- | 0.1% Xanthan | 0.3% Guar | smooth, thin, |
| carra. | Gum (or NPX) | Gum | stringy upon stirring |
| 0.08% iota- | 0.1% Xanthan | 0.3% Guar | smooth, but very |
| carra. | Gum (or NPX) | Gum | thin |

The textures of the yogurts containing the components listed in Table 2 indicated that lower iota-carrageenan content generally caused graininess, while higher iota-carrageenan content yielded a yogurt product with less body. To avoid these effects, the desired content of iota-carrageenan in these specific yogurt products was determined to be from 0.04% to 0.06% by weight of the yogurt product.

### Example 8

### Galactomannan Testing and Additional Yogurt Samples Containing Stabilizing Additives

Additional testing determined that the addition of the galactomannan tara gum to the stabilizing additives described herein produced yogurt products with desirable properties. Using the techniques described in Example 4, additional yogurt samples were produced that contained a stabilizing additive that included xanthan gum (or NPX), iota-carrageenan, and tara gum. Specifically, a yogurt was produced containing NPX in an amount of 0.32% by weight of the yogurt, iota-carrageenan in an amount of 0.04% by weight of the yogurt, and tara gum in an amount of 0.08% by weight of the yogurt. The yogurt had a smooth, creamy, soft, and light texture, and had good shape retention and oral mouthfeel and viscosity. Instead of tara gum, the yogurt samples of this example can be prepared using fenugreek gum, guar gum, locust bean gum, or any combination thereof to obtain similar results. Alternatively, tara gum can be used in combination with one or more of fenugreek gum, guar gum, and/or locust bean gum.

### Example 9

### Yogurt Sample Containing Starch

Using the techniques described in Example 4, a yogurt sample was made containing a stabilizing additive and starch. Specifically, a yogurt was produced containing iota-carrageenan CJ in an amount of 0.04% by weight of the yogurt, NPX in an amount of 0.32% by weight of the yogurt, and tara gum in an amount of 0.08% by weight of the yogurt. Also added to the yogurt was starch in an amount of 1.25% by weight of the yogurt. The starch was added together with the components of the stabilizing additive. The resulting yogurt had a shiny, smooth texture that was very similar to a gelatin-containing yogurt and pectin-containing yogurt. The product also had a good sharpness of edge, oral viscosity, and mouthfeel.

Various modifications and variations can be made to the compounds, compositions and methods described herein. Other aspects of the compounds, compositions, and methods described herein will be apparent from consideration of the specification and practice of the compounds, compositions, and methods disclosed herein. It is intended that the specification and examples be considered as exemplary.

1. An edible composition comprising fermented milk and a stabilizing additive, wherein the stabilizing additive comprises:
(a) xanthan gum, and
(b) iota-carrageenan,
wherein the weight percentage of the xanthan gum in the stabilizing additive is higher than the weight percentage of the iota-carrageenan.

2. The edible composition of claim 1, wherein the xanthan gum is native xanthan gum, reduced pyruvate xanthan gum (RPX), non-pyruvylated xanthan gum (NPX), or any combination thereof.

3. The edible composition of claim 1, wherein the xanthan gum is present in the stabilizing additive in an amount of at least about 50% by weight of the stabilizing additive.

4. The edible composition of claim 1, wherein the xanthan gum is present in the stabilizing additive in an amount of at least about 60% by weight of the stabilizing additive.

5. The edible composition of claim 1, wherein the xanthan gum is present in the stabilizing additive in an amount of at least about 70% by weight of the stabilizing additive.

6. The edible composition of claim 1, wherein the xanthan gum is present in the stabilizing additive in an amount of at least about 80% by weight of the stabilizing additive.

7. The edible composition of claim 1, wherein the xanthan gum is present in the stabilizing additive in an amount of at least about 90% by weight of the stabilizing additive.

8. The edible composition of claim 1, wherein the iota-carrageenan is present in the stabilizing additive in an amount of from about 5 to about 25% by weight of the stabilizing additive.

9. The edible composition of claim 1, wherein the iota-carrageenan is present in the stabilizing additive in an amount of about 10% by weight of the stabilizing additive.

10. The edible composition of claim 1, wherein the stabilizing additive further comprises at least one galactomannan.

11. The edible composition of claim 10, wherein the at least one galactomannan comprises guar gum, tara gum, locust bean gum, fenugreek gum, or any combination thereof.

12. The edible composition of claim 10, wherein the at least one galactomannan is tara gum.

13. The edible composition of claim 10, wherein the galactomannan is present in the stabilizing additive in an amount of from about 5 to about 35% by weight of the stabilizing additive.

14. The edible composition of claim 10, wherein the galactomannan is present in the stabilizing additive in an amount of from about 15 to about 25% by weight of the stabilizing additive.

15. The edible composition of claim 1, wherein the stabilizing additive is present in the edible composition in an amount of from about 0.1 to about 1.0% by weight of the edible composition.

16. The edible composition of claim 1, wherein the xanthan gum is present in the edible composition in an amount of from about 0.1 to about 1.0% by weight of the edible composition.

17. The edible composition of claim 1, wherein the iota-carrageenan is present in the edible composition in an amount of from about 0.01 to about 0.1% by weight of the edible composition.

18. The edible composition of claim 1, wherein the ratio of xanthan gum to iota-carrageenan in the stabilizing additive is from about 19:1 to about 3:1.

19. The edible composition of claim 1, wherein the ratio of xanthan gum to iota-carrageenan in the stabilizing additive is about 10:1.

20. The edible composition of claim 1, wherein the edible composition and the stabilizing additive are substantially free of microcrystalline cellulose and cellulose fibers.

21. The edible composition of claim 1, wherein the edible composition further comprises starch.

22. The edible composition of claim 21, wherein the starch is a modified starch.

23. The edible composition of claim 21, wherein the stabilizing additive and starch are present in the edible composition in a ratio of about 1:1 to about 1:5.

24. A method for making a fermented milk product comprising:
adding a stabilizing additive to milk; and
fermenting the milk;
wherein the stabilizing additive comprises xanthan gum, and iota-carrageenan, wherein the weight percentage of the xanthan gum in the stabilizing additive is higher than the weight percentage of the iota-carrageenan.

25. The method of claim 24, further comprising adding a starch to the milk prior to or after fermentation.

26. A method for making a fermented milk product comprising:
fermenting milk; and
adding a stabilizing additive to the fermented milk;
wherein the stabilizing additive comprises xanthan gum and iota-carrageenan, wherein the weight percentage of the xanthan gum in the stabilizing additive is higher than the weight percentage of the iota-carrageenan.

27. The method of claim 26, further comprising adding a starch to the milk prior to fermentation or to the fermented milk.
